(19) United States
(12) Patent Application Publication
(10) Pub. No.: US 2010/0289616 A1
(43) Pub. Date: Nov. 18, 2010

(54) MOVABLE BARRIER SYSTEM ADAPTED TO UTILIZE BIOMETRIC TECHNOLOGY TO IDENTIFY AND AUTHORIZE ACCESS TO PREMISES

(76) Inventors: ALI TEHRANCHI, Newport Coast, CA (US); Daniel Perez, Foothill Ranch, CA (US)

Correspondence Address: JAFARI LAW GROUP, P.C., 801 N. PARKCENTER DRIVE, SUITE 220, SANTA ANA, CA, 92705, US

(21) Appl. No.: 12/467,469

(22) Filed: May 18, 2009

(51) Int. Cl. G06F 7/04

(52) U.S. Cl. 340/5.7

(57) ABSTRACT

The invention is a movable barrier system for controlling access to a secured premise utilizing biometric technology. More particularly, a system in accordance with the present invention comprises a movable barrier, an operator adapted to control movement of the movable barrier, and a biometric device adapted to sense a user's biometric parameters to identify and authorize the user to control access to the premises. When a user enters his or her biometric parameter in the biometric device and the user's biometric parameter is matched and identified, the biometric device generates a security signal to the movable barrier operator indicating the user is authorized to control access. The user enters a command to the movable barrier that is received by the movable barrier operator. The movable barrier operator relays the command to the movable barrier and the movable barrier performs in accordance to the command.

### TECHNICAL FIELD OF THE INVENTION

The present invention relates generally to a system to control access to a premise, and in particular, a movable barrier system adapted to utilize technology to identify and authorize a user to control an access point to a secured premise.

### COPYRIGHT & TRADEMARK NOTICE

A portion of the disclosure of this patent application may contain material that is subject to copyright protection. The owner has no objection to the facsimile reproduction by any one of the patent document or the patent disclosure, as it appears in the Patent and Trademark Office patent file or records, but otherwise reserves all copyrights whatsoever.

Certain marks referenced herein may be common law or registered trademarks of third parties affiliated or unaffiliated with the applicant or the assignee. Use of these marks is by way of example and shall not be construed as descriptive or to limit the scope of this invention to material associated only with such marks.

### BACKGROUND OF THE INVENTION

Movable barriers, such as entry doors, garage doors, and gates provide a measure of security to prevent unauthorized persons from accessing a secured premise. In the past, movable barriers were manually operated by guards or attendants who granted access to a secured premise. Advancements in technology have allowed for automated movable barrier systems, which may include a movable barrier, movable barrier operators and an access point to command the movable barrier to open or close. A fundamental aspect of automated entry systems is the use of a remote device to gain access to a secured premise.

An alternative to the use of a remote device is the use of a keypad at a gate terminal requiring a numeric or alpha-numeric pass code to gain access to a secured premise. The remote device and numeric or alpha-numeric code provide a layer of security to allow a user to control access to a secured premise and prevent unauthorized persons from entry. These security measures, however, may easily be compromised by either theft or loss of the remote device, or dissemination of the numeric or alpha-numeric pass code to a third party. Should a security measure be compromised, remedying the situation often inconveniences the population that uses the security system for entry. If, however, a movable barrier system could provide a sound measure of protection tailored to each individual user, the movable barrier system would eliminate unauthorized persons from entering a secured premise. Therefore, there is a need in the art for a movable barrier system that can provide access to a user based upon the user's individual traits or characteristics.

The current systems of remote devices and numeric or alpha-numeric pass codes provide limited protection. Security measures in addition to remote devices and numeric or alpha-numeric pass codes are cost-prohibitive or not efficient with the use of the movable barrier system. Presently, the art has been unable to adequately solve this problem. There is a need in the art for a movable barrier system adapted to utilize biometric technology to identify and authorize control access to a premise. It is to these ends that the present invention has been developed.

### SUMMARY OF THE INVENTION

To minimize the limitations in the prior art, and to minimize other limitations that will be apparent upon reading and understanding the present specification, the present invention describes a movable barrier system adapted to utilize biometric technology to identify and authorize a user to control access to a premise.

A system according to the present invention may comprise a biometric device adapted to sense a biometric parameter of a user and generate a security signal indicative of whether the user is authorized to control access, and a movable barrier operator adapted to receive a command from the user and control movable barrier in response to the command only if the security signal indicates the user is authorized.

Additionally, a system according to the present invention may comprise a biometric device adapted to sense a biometric parameter of a user and generate a security signal indicative of whether the user is authorized to control access, and a movable barrier operator adapted to control the movable barrier in response to the security signal.

It is an objective of the present invention to utilize biometric technology to identify and authorize a user access to a secured premise.

It is another objective of the present invention to utilize biometric technology to allow the user to control access to a secured premise.

It is yet another objective of the present invention to increase protection and to prevent unauthorized persons to enter into a secured premise.

These and other advantages and features of the present invention are described herein with specificity so as to make the present invention understandable to one of ordinary skill in the art.

### BRIEF DESCRIPTION OF THE DRAWINGS

Elements in the figures have not necessarily been drawn to scale in order to enhance their clarity and improve understanding of these various elements and embodiments of the invention. Furthermore, elements that are known to be common and well understood to those in the industry are not depicted in order to provide a clear view of the various embodiments of the invention.

FIG. 1(a) illustrates a basic layout of a system of an exemplary embodiment of a movable barrier system adapted to utilize biometric technology to identify and authorize a user to control access to a secured premise.

FIG. 1(b) illustrates a block diagram of an exemplary embodiment of a movable barrier system adapted to utilize biometric technology to identify and authorize a user to control access to a secured premise.

FIG. 2 illustrates a flow chart of a process in accordance with an exemplary embodiment of the present invention for identifying and authorizing a user to control access a secured premise utilizing biometric technology.

FIG. 3 illustrates a block diagram of an exemplary embodiment of a movable barrier system adapted to utilize biometric technology and a remote device to identify and authorize a user to control access to a secured premise.

FIG. 4(a) illustrates a block diagram of an exemplary embodiment of a movable barrier system adapted to utilize biometric technology including a biometric device embedded in a remote device to identify and authorize a user to control access to a secured premise.

FIG. 4(b) illustrates a block diagram of an exemplary embodiment of the internal components of a remote device.

### DETAILED DESCRIPTION OF THE DRAWINGS

In the following discussion that addresses a number of embodiments and applications of the present invention, reference is made to the accompanying drawings that form a part hereof, where depictions are made, by way of illustration, of specific embodiments in which the invention may be practiced. It is to be understood that other embodiments may be utilized and changes may be made without departing from the scope of the present invention.

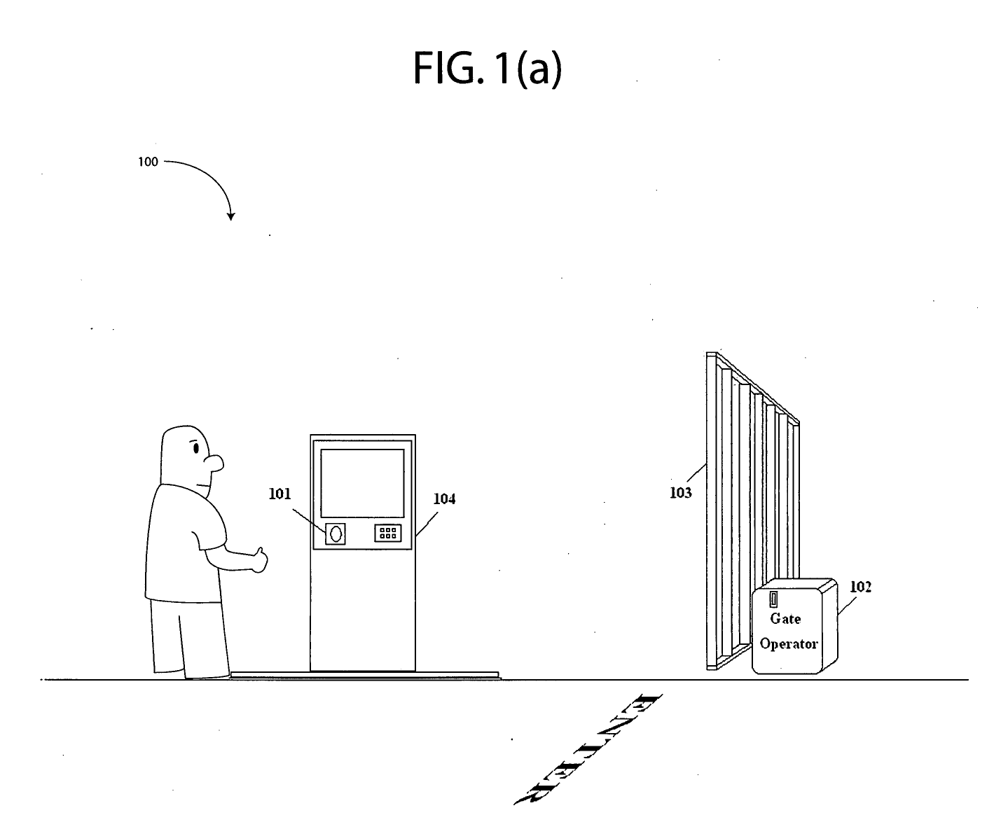

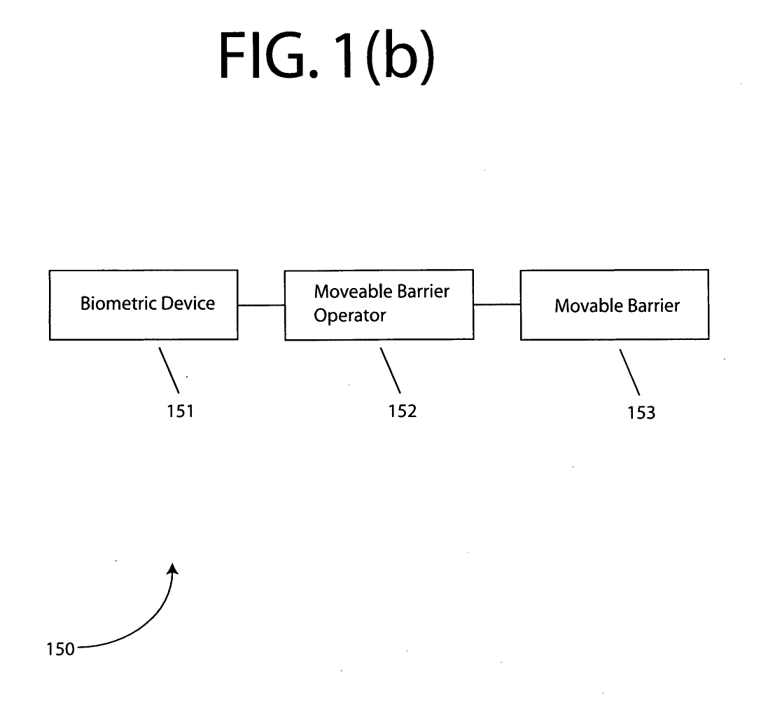

FIG. 1(a) illustrates a basic layout of a system of an exemplary embodiment of movable barrier system in which a biometric device identifies and authorizes a user and generates a security signal to a movable barrier operator, and said movable barrier operator is adapted to control movement of a movable barrier. FIG. 1(a) shows movable barrier system 100, which includes a biometric device 101, movable barrier operator 102, movable barrier 103 and access device 104. Movable barrier operator 102 facilitates commands from access device 104 to movable barrier 103. Biometric device is enclosed in access device 104. Biometric device 101 may be capable of communicating to access device 104. Access device 104 is capable of communicating with movable barrier operator 102. Movable barrier operator 102 is connected to movable barrier 103.

In an exemplary embodiment of movable barrier system 100, a resident of a gated apartment community may return home. The resident approaches access device 104 and enters his or her biometric parameter into biometric device 101. A search is performed comparing the resident's biometric parameter to the resident's previously obtained biometric parameter. Once there is a match, a user interface appears on the display monitor giving the resident a set of options to choose from. The resident presses the “OPEN GATE” button, the gate opens and the resident enters. A clear benefit is the ease that the resident may enter the gated apartment community. There is no hassle of locating a remote gate opener or remembering the numeric or alpha-numeric pass code. Movable barrier system 100 allows the resident greater security since the resident's biometric information is unique. Any non-resident would be unable to enter the gated apartment community unless one of the residents granted access.

In another exemplary embodiment of movable barrier system 100, a frequent visitor may visit a resident of the gated apartment community. The frequent visitor enters his or her biometric parameter at biometric device 101. A search is performed and the frequent visitor is identified and authorized. A user interface appears and the frequent visitor presses the “OPEN GATE” button, the gate opens and the frequent visitor enters. The resident benefits from having the frequent visitor enter without requiring the resident to be home or requiring the resident to stop their activities to grant a visitor entrance. If the resident no longer wishes to allow the frequent visitor to access the gated apartment community, the resident would inform the apartment manager of his or her wish. The apartment manager would delete the frequent visitor from the database. The next time frequent visitor enters his or her biometric information he or she will be denied access to the user interface and would be unable to open the gate. The resident benefits from movable barrier system 100 by not having to retrieve a remote gate opener from the frequent visitor. Additionally, the entire gated apartment community is not inconvenienced by the required change in the numeric or alpha-numeric pass code.

In yet another exemplary embodiment of movable barrier system 100, a housekeeper may enter to clean a resident's apartment. The housekeeper enters his or her biometric parameter at biometric device 101. A search is performed and the housekeeper is identified and authorized. A user interface appears and the housekeeper presses the “OPEN GATE” button, the gate opens and the housekeeper enters. The resident may request that the housekeeper only come during specified hours of the day, for example, regular business hours. The apartment manager would include the additional time restriction into the database. If the housekeeper attempts to enter at a time other than regular business hours, biometric device 101 would make an identification but would deny access since the time is not within the authorized range. The resident or apartment manager may restrict access to the gated apartment community by certain guests with a time restriction included in the database. This provides greater control and a greater security to the residents in allowing restricted access to guests who must regularly enter into the premises.

In still another exemplary embodiment of movable barrier system 100, an apartment manager may enter his or her biometric parameter at biometric device 101. The apartment manager has access to the user interface that includes diagnostic programs associated with movable barrier system 100. The apartment manager has the highest security clearance and may access programs that are necessary to ensure that movable barrier system 100 is functioning properly at all times. Residents would have access to a user interface without access to any diagnostic programs for movable barrier system 100. Frequent visitors and others who enter the gated apartment community have a restricted user interface that is limited to an “OPEN GATE” button. The above examples, however, should not be interpreted to limit the scope of the present invention.

Biometric device 101 is a device designed to receive a user's biometric parameter and identify the user. Biometric device 101 analyzes the user's biometric parameter for key markers and executes a search in a database of key markers of authorized users. The user is identified when biometric device 101 matches the user's biometric parameter with parameters in a database. An exemplary embodiment of biometric device 101 is a device that receives a user's biometric parameter, executes a database search and identifies the user based on a match in the database in a few seconds.

Examples of biometric parameter that biometric device 101 is capable of receiving include, but are not limited to, fingerprint scans, handprint scans, retinal scans, facial scans and voice prints. In one exemplary embodiment, biometric device 101 may comprise a fingerprint scanner, which receives a user's finger and may generate an image of the user's fingerprint. In such an embodiment, biometric device 101 analyzes the fingerprint scan for key markers and executes a database search to locate a user's previously obtained biometric parameter containing the same key markers. The user is identified when search results in a match between the user's biometric parameter and the user's previously obtained biometric parameter contained in the database. Biometric device 101 generates a security signal to movable barrier operator 102 indicating the user is authorized.

In another embodiment of the present invention, biometric device 101 may be a face scanner, which receives a user's face and may generate an image of the user's face. In such an embodiment, biometric device 101 analyzes the face scan for key markers and executes a database search to locate a user's previously obtained biometric parameter containing the same key markers. The user is identified when the search results in a match between the user's biometric parameter and the user's previously obtained biometric parameter contained in the database. Biometric device 101 generates a security signal to movable barrier operator 102 indicating the user is authorized.

In yet another embodiment, biometric device 101 may be a voice recognition system. In exemplary usage of such an embodiment of the present invention, a user may speak into a microphone, which may be included in biometric device 101. The user's voice will pass through an amplifier, echo canceller and voice enhancer and be converted into digital data at an analog/digital converter. Once the software in biometric device 101 recognizes the voice sample provided by the user, the software derives an identification data that can be used to match that data with names in a database that are associated with the identification process. Upon finding a match, the user is identified and biometric device 101 generates a security signal to movable barrier 102 indicating the user is authorized.

In yet another embodiment of the present invention, biometric device 101 may be a retina scanner, which may receive a user's retina and generates an image of the user's retina. Biometric device 101 analyzes the retina scan for key markers and executes a database search to locate a user's previously obtained biometric parameter containing the same key markers. The user is identified when the search results in a match between the user's biometric parameter and the user's previously obtained biometric parameters contained in the database. Biometric device 101 generates a security signal to movable barrier operator 102 indicating the user is authorized.

In still another embodiment of the present invention, biometric device 101 may be a handprint scanner, which may receive a user's hand and generates an image of the user's handprint. Biometric device 101 analyzes the handprint image for key markers and executes a database search to locate a user's previously obtained biometric parameter containing the same key markers. The user is identified when the search results in a match between the user's biometric parameter and the user's previously obtained biometric parameter contained in the database. Biometric device 101 generates a security signal to movable barrier operator 102 indicating the user is authorized.

Key markers analyzed by biometric device 101 may vary depending upon the biometric parameter that is received. For example, fingerprint analysis may be based upon an impression created by the minute raised ridges of skin on the inside surface of a user's fingers. Each individual user creates a unique set of data points, which may include ridge ending, short ridge or island, bifurcation, lake or enclosure, dot, spur and crossover or bridge. An initial sample fingerprint may be analyzed by biometric device 101 and entered into a database for storage. The analyzed sample may be compared to users' biometric parameter each occasion they attempt to enter the secured premise. Similarly, handprints or palm prints may undergo a similar process.

Key marker analysis performed by biometric device 101 would work differently in another embodiment of the present invention. Should biometric device 101 perform retina scans, biometric device 101 may analyze key biometric markers in the capillary network of a user's eye. The retina scanner may create a map of the unique capillary network pattern from the retina of the user. Since the capillary network of a user is never identical to another user, the map of one user is a distinct set of markers and different from all other users. Biometric device 101 may analyze an initial sample retina scan and create an image and the image may be stored in a database. When a user attempts to access the secured premises, biometric device 101 compares the retina image in the database with the user's retina scan to determine if there is a match.

Another example of key biometric markers is a face scanner. In an embodiment of biometric device 101 utilizing facial recognition, facial analysis performed by biometric device 101 may be based on the user's physical attributes of the face. A scanner may analyze data points on the face of the user and may create an image based upon the selected data points. The greater the number of data points the greater accuracy in differentiating the users. An initial sample face image may be analyzed by biometric device 101 and entered into a database for storage. The analyzed sample may be compared to users' biometric parameter each occasion they attempt to enter the secured premise. The above examples, however, should not be interpreted to limit the scope of the present invention.

Biometric device 101 may be used in conjunction with a database that is able to store biometric parameters and compare that biometric parameter with a user's biometric parameter. The database may include biometric parameters for a plurality of authorized users. An example of such a database may be a server that is connected to biometric device 101. Each time a user enters his or her biometric parameter at biometric device 101, biometric device 101 may execute a search of the database to match and identify the user. Another example of such a database may be a desktop computer that may be connected to biometric device 101. The desktop computer performs the search of the authorized users on a hard drive. Yet another example may be a database that is off-site and is utilized by biometric device 101 through a wireless interface, cellular telephone connection or internet connection. Once a user enters his or her biometric parameter, biometric device 101 may wirelessly transmit the biometric parameter to the off-site database to execute a search. Once the search is complete the database wirelessly transmits a message to biometric device 101 indicating whether the user is a match and authorized or is not a match and deny access. These examples, however, should not be interpreted to limit the scope of the present invention.

In an exemplary embodiment of movable barrier system 100, in a gated residential community, a property manager may be responsible for accessing, entering and downloading a user's biometric parameter into a database. The database may be located at access device 104, in the property manager's office or an area in close proximity that is easily accessible by the property manager. In another embodiment of the present invention, a database may be contained within a computer server. The server may be stored with many other servers in a central location under the management of a single company that provides service to a plurality of gated premises and buildings. The central location of the servers may be located in close proximity or far away from the gated premises and buildings. Biometric device 101 may communicate with the database through the use of internet, wi-fi or telephone network.

Movable barrier operator 102 may be any machine or system that controls the movement of the movable barrier 103. Movable barrier operator 102 may move movable barrier 103 to its open position, its closed position, or to any position in between. Movable barrier operator 102 may also start or stop movement of movable barrier 103 at any point along the movement track of movable barrier 103. In an exemplary embodiment where movable barrier 103 is a horizontally sliding gate, movable barrier operator 102 may control the horizontal sliding motion of movable barrier 103. In another exemplary embodiment where movable barrier 103 is an upward swinging garage door, movable barrier operator 102 may control the pivot swinging motion of movable barrier 103.

Movable barrier 103 is an object designed to obstruct an opening in its closed position. Movable barrier 103 may be moved to an open or partially open position, thereby not obstructing or only partially obstructing said opening. Movable barrier 103 may be a door or window for a small entity (i.e. a vehicle), or a gate for a large entity (i.e. a building). In various embodiments, movable barrier 103 may swing, slide, pivot, fold or roll. These examples should not limit the scope as to what may constitute movable barrier 103 or limit its motion possibilities.

Access device 104 is a device designed to provide an interface to a user to send commands to movable gate operator 102. In an exemplary embodiment of the present invention, access device 104 may house a display monitor, a database, a key pad and biometric device 101. A user may approach the access device and enter his or her biometric parameters. The display monitor may provide the user with instructions on entering his or her biometric parameters. Additionally, the display monitor may prompt a menu of options for the user to choose from, if the user is authorized by biometric device 101. In another embodiment of the present invention, access device 104 may house a touch-screen display monitor that may be capable of scanning a user's fingerprint or handprint and transmitting the data to biometric device 101.

Access device 104 may be situated on a driveway in close proximity to the entrance or movable barrier 103. Additionally, access device 104 may be installed in a lobby to a building, on the entrance to a parking lot, near the doorway to a house, or any other access point to any type of premise, without departing from the scope of the present invention.

Access device 104 is capable of communicating with movable barrier operator 102. The communication may be through a physical line, for example, but without limiting the scope of the invention, a telephone network or an internet connection. Alternatively, access device 104 may be capable of communicating wirelessly with movable barrier operator 102.

An additionally layer of security provided by access device 104 may restrict access to certain users during certain hours. For example, an authorized public works employee may be denied access to the premises by access device 104 if the user is attempting to enter during a pre-programmed time range that the user is not authorized to access, such as during nightfall.

As a way of illustration, without limiting the scope of the present invention, a user may approach access device 104 on foot or in an automobile. The user may enter his or her biometric parameter into biometric device 101 at access device 104 located in close proximity to movable barrier operator 102. Biometric device 101 may then execute a search of a database seeking a user's previously obtained biometric parameter containing the same key markers as the user's biometric parameter. A database may contain the user's previously obtained biometric parameter. The database may be located, for example and without limiting the scope of the invention, at access device 104, a central processing center or an off-site location accessible by the internet, wi-fi or telephone network. Once the user's biometric parameter matches the user's previously obtained biometric parameter with the same key markers in a database, the user is identified. Biometric device 101 generates a security signal to movable barrier operator 102 indicating the user is authorized. The user accesses a user interface at access device 104 and generates a command to movable barrier operator 102. Movable barrier operator receives the user's command and sends a signal to movable barrier 103 to open and allow entrance to the premises.

Another example, without limiting the scope of the present invention, is an automated system, wherein a user may approach access device 104 on foot or in an automobile. The user may enter his or her biometric parameter into biometric device 101 at access device 104 located in short proximity to movable barrier operator 102. Biometric device 101 executes a search of a database seeking a user's previously obtained biometric parameter containing the same key markers as the user's biometric parameter. A database may contain the user's previously obtained biometric parameter. The database may be located, for example and without limiting the scope of the invention, at access device 104, a central processing center or an off-site location accessible by the internet, wi-fi or telephone network. Once the user's biometric parameter matches the user's previously obtained biometric parameter with the same key markers in a database, the user is identified. Biometric device 101 generates an automated command signal to movable barrier operator 102. Movable barrier operator 102 receives the user's command and sends the signal to movable barrier 103 to perform the command. Movable barrier 103 performs according to the command.

Turning to the next figure, FIG. 1(b) illustrates block diagram of an exemplary embodiment of movable barrier system in which a biometric device identifies and authorizes a user and generates a security signal to a movable barrier operator, and said movable barrier operator is adapted to control movement of a movable barrier. FIG. 1(b) shows movable barrier system 150, which includes a biometric device 151, movable barrier operator 152 and movable barrier 153. Movable barrier operator 152 facilitates commands from biometric device 151 to movable barrier 153. Biometric device 151 may be capable of communicating to movable barrier operator 152. Movable barrier operator 152 is connected to movable barrier 153.

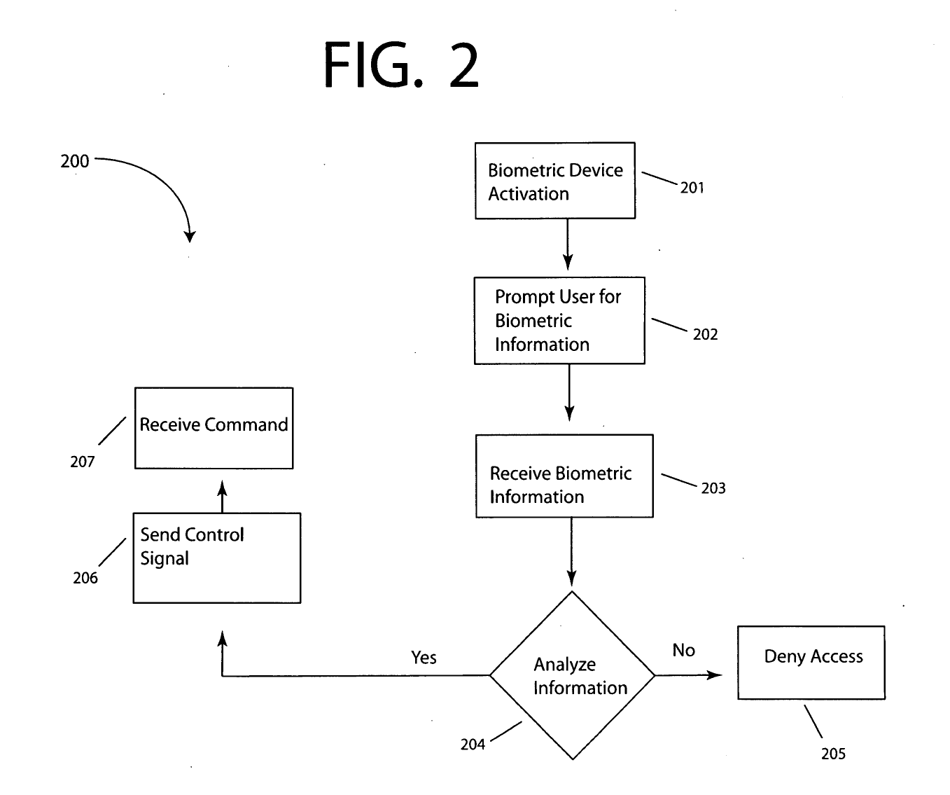

Moving to the next figure, FIG. 2 illustrates a flow chart of a process in accordance with an exemplary embodiment of the present invention for identifying and authorizing a user to control access a secured premise utilizing biometric technology. Process 200 is explained in the order detailed below; however the following steps may be taken in any other conceivable sequence without deviating from the scope of the present invention.

In step 201, the biometric device is activated. In exemplary usage of the present invention a user may approach the access device and activate the biometric device software by pressing a button at the access device. In another embodiment a sensor may be located in close proximity to the biometric device and detect the user's presence, thus generating a signal to the biometric device to activate the software. In yet another embodiment of the present invention a user may activate the biometric device by pressing a button on a remote device.

In step 202, a user is prompted to input his or her biometric parameter. In an exemplary embodiment, a user interface may prompt the user to input his or her biometric parameter. In another embodiment, media may prompt instructions to the user describing the steps to enter specific biometric parameter.

In step 203, a user may enter his or her biometric parameter into the biometric device. The biometric device may include fingerprint scanners, handprint scanners, face scanners, retina scanners or audible voice recordings to receive the biometric parameter. The Biometric device may receive biometric parameter corresponding to the biometric technology utilized by biometric device. In an exemplary embodiment of a biometric device utilizing fingerprint scanning technology, a user may input their fingerprint by placing their finger upon a corresponding fingerprint scanner. In another exemplary embodiment, should the biometric device utilize voice recognition technology, the user may input a voice sample by audibly speaking into a corresponding microphone.

In step 204, the biometric device may analyze a user's biometric parameter for key markers. To analyze the user's biometric parameter, the biometric device may execute a search of a database that contains a user's previously obtained biometric parameter. The biometric device may compare the user's inputted biometric parameter with the biometric parameter of authorized users in the database, searching for an exact match of key markers. Should biometric device not find an exact match between the biometric parameter provided by the user and the biometric parameter stored in the database, biometric device may proceed to step 205. Should biometric device find an exact match between the biometric parameter provided by the user and biometric parameter stored in the database, biometric device may proceed to step 206.

In step 205, the biometric device may deny a user access to the movable barrier system. A user that is not authorized is denied access to the system.

In step 206, the biometric device may send a control signal to movable barrier operator. Authorized users are granted access to the system. When a match is found in step 204, the biometric device sends a control signal to the movable barrier operator.

In step 207, movable barrier operator receives a command from the biometric device and performs accordingly. In an exemplary embodiment of the present invention, the user may be prompted with a user interface by the movable barrier operator for instructions. Instructions may include commands to open, close, and to start or stop movement of the movable barrier. The list of instructions, however, should not limit the scope as to what functions a user interface may command in the present invention. In another embodiment of the present invention, the movable barrier operator may automate a command to open or close the movable barrier.

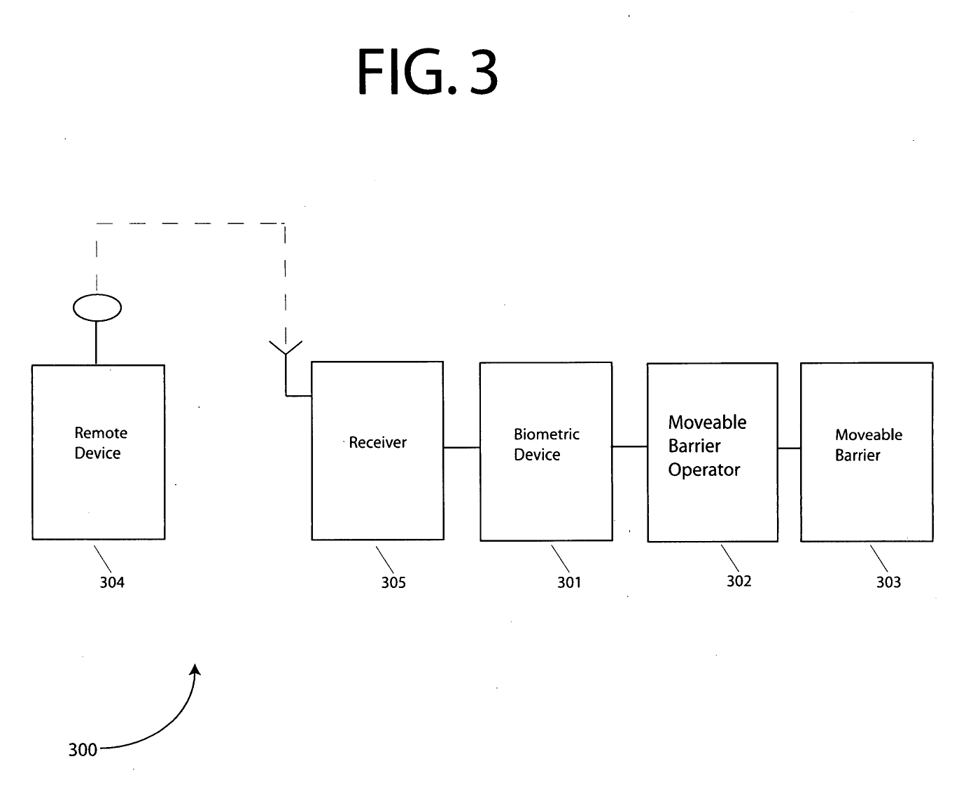

Moving to the next figure, FIG. 3 illustrates a block diagram of an exemplary embodiment of movable barrier system in which a remote device receives biometric parameter and transmits the parameter to a receiver. The receiver relays the parameter to the biometric device, which generates a security signal to a movable barrier operator, and said movable barrier is adapted to control movement of a movable barrier. FIG. 3 shows movable barrier system 300, which includes a biometric device 301, movable barrier operator 302, movable barrier 303, remote device 304 and receiver 305. Movable barrier system 300 is designed to provide the functionality of a movable barrier 303 in conjunction with movable barrier operator 302, but to additionally provide access utilizing biometric parameter.

Biometric device 301 is a device designed to analyze biometric parameter and identify a user. Biometric device 301 receives biometric parameter via receiver 305 and analyzes the biometric parameter for key markers. Biometric device 301 executes a database search of authorized users seeking an exact match of key markers. In an exemplary embodiment, biometric device 301 is connected to a database containing a user's previously obtained biometric parameter. The database may be located within the access device. In another embodiment, a database may be located in an off-site location and biometric device 301 may communicate with the database wireless, through an internet connection, or a cellular telephone network or a telephone network. Once biometric device 301 has confirmed a match, the user is identified and biometric device 301 generates a security signal to movable barrier operator 302 indicating that the user is authorized.

Examples of biometric parameter that may be analyzed by biometric device 301 may include, but are not limited to, fingerprints, facial images, handprints, retinal scans and voice recordings.

Remote device 304 is any device capable of receiving a user's biometric parameter and transmitting the user's biometric parameter to receiver 305. In an exemplary embodiment, remote device 304 is a device that may transmit signals wirelessly to receiver 305. Examples of such device include, but not limited to, cellular phones, Bluetooth® enabled devices, personal digital assistants, notebook computers, remote garage door openers or remote gate openers.

In an exemplary embodiment, remote device 304 may transmit information to receiver 305 wirelessly through a cellular network. In another embodiment, remote device 304 may transmit information to receiver 305 wirelessly through a wi-fi network. In yet another embodiment, remote device 304 may transmit information to receiver 305 wirelessly through a Bluetooth® network. These examples, however, should not be interpreted to limit the scope of the present invention.

Receiver 305 is a device capable of receiving a transmission from remote device 304. In an exemplary embodiment of the present invention, receiver 305 is capable of receiving wireless transmissions. A wireless receiver may either be an antenna or a satellite dish. Receiver 305 may be programmed to receive transmissions from a select plurality of remote devices. For example, without limiting the scope of the invention, remote device 304 and receiver 305 may share the same communication frequency. Another example may include remote device 304 dialing into receiver 305 to transmit biometric parameter.

As a way of illustration, without limiting the scope of the present invention, a user may enter his or her biometric parameter into remote device 304. Remote device 304 may then transmit the biometric parameter to receiver 305, which relays the biometric parameter to biometric device 301. Biometric device 301 may analyze the biometric parameter for key markers and executes a search for an exact match of key markers in a database of authorized users. If there is a match, the user is identified. A database may contain the user's previously obtained biometric parameter. The database may be located, for example and without limiting the scope of the invention, at an access device, a central processing center or an off-site location accessible by the internet, wi-fi or telephone network. Once identified, biometric device 301 generates a security signal to movable barrier operator 302 indicating the user is authorized. The user may access a user interface on remote device 304 and generate a command to movable barrier operator 302. Movable barrier operator 302 receives a command from a user interface and sends the command to movable barrier 303 to perform according to the command.

Another example, without limiting the scope of the present invention, is an automated system, wherein a user may enter his or her biometric parameter into remote device 304. Remote device 304 may then transmit the biometric parameter to receiver 305, which relays the biometric parameters to biometric device 301. Biometric device 301 may analyze the biometric parameter for key markers and executes a search for an exact match of key markers in a database of authorized users. A database may contain the user's previously obtained biometric parameter. The database may be located, for example and without limiting the scope of the invention, at an access device, a central processing center or an off-site location accessible by the internet, wi-fi or telephone network. Once the user's biometric parameter matches the user's previously obtained biometric parameter with the same key markers in a database, the user is identified. Biometric device 301 may generate an automated command signal to movable barrier operator 302. Movable barrier operator 302 receives the user's command and sends the signal to movable barrier 303 to perform the command. Movable barrier 303 performs according to the command.

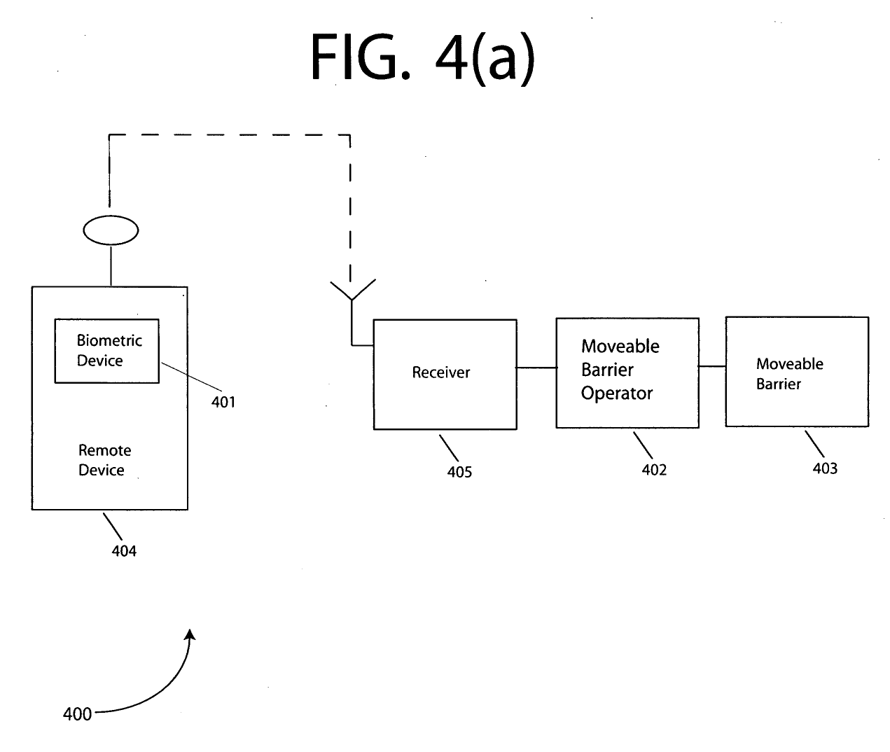

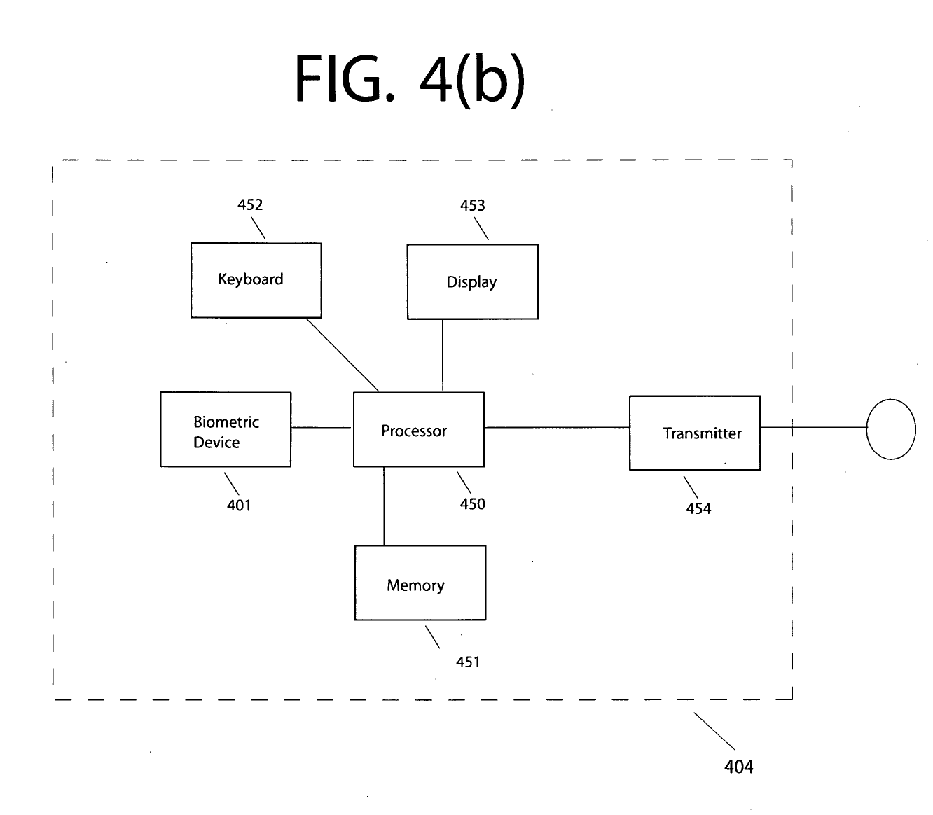

FIG. 4(a) illustrates a block diagram of an exemplary embodiment of movable barrier system in which a biometric device embedded in a remote device generates a security signal to a movable barrier operator, and said movable barrier is adapted to control movement of a movable barrier. FIG. 4(a) shows movable barrier system 400 which includes a biometric device 401, movable barrier operator 402, movable barrier 403, remote device 404 and receiver 405. Movable barrier system 400 is designed to provide the functionality of a movable barrier 403 in conjunction with movable barrier operator 403, but to additionally provide access utilizing biometric parameter.

Biometric device 401 is a device designed to receive a user's biometric parameter and identify the user. Biometric device 401 analyzes the user's biometric parameter for key markers and executes a search in a database of key markers of authorized users. The user is identified when biometric device 401 matches the user's biometric parameter with parameter in a database. An exemplary embodiment of biometric device 401 is a device that receives a user's biometric parameter, executes a database search and identifies the user based on a match in the database in a few seconds.

In an exemplary embodiment, biometric device 401 may include a key marker database for a single authorized user for a particular remote device. In another embodiment, biometric device 401 may include a key marker database for a plurality of authorized users for a particular remote device.

Examples of biometric device 401 include, but not limited to, fingerprint scanners, handprint scanners, retinal scanners, facial scanners and microphone adapted to analyze voices. In an exemplary embodiment biometric device 401 may be embedded in remote device 404.

Biometric device 401 may be embedded within, proximate or adjacent to remote device 404. Remote device 404 is any device capable of transmitting the user's biometric parameter to receiver 405. In an exemplary embodiment remote device 404 is a device that may transmit signals wirelessly to receiver 405. Examples of such device include, but not limited to, cellular phones, Bluetooth® enabled devices, personal digital assistants, notebook computers, remote garage door openers or remote gate openers.

Receiver 405 is a device capable of receiving a transmission from remote device 404. In an exemplary embodiment receiver 405 is capable of receiving wireless transmissions. A wireless receiver may either be an antenna or a satellite dish. Receiver 405 may be programmed to receive transmissions from a select plurality of remote devices. For example, without limiting the scope of the invention, remote device 404 and receiver 405 may share the same communication frequency. Another example may include remote device 404 dialing into receiver 405 to transmit biometric parameter.

As a way of illustration, without limiting the scope of the present invention, a user may enter his or her biometric parameter into biometric device 401 which may be embedded in remote device 404. Biometric device 401 may then analyze the biometric parameter for key markers and executes a search for an exact match of key markers in a database of authorized users. A database may contain the user's previously obtained biometric parameter. The database may be located, for example and without limiting the scope of the invention, at remote device 404, an access device, a central processing center or an off-site location accessible by the internet, wi-fi or telephone network. Once the user's biometric parameter matches the user's previously obtained biometric parameter with the same key markers in a database, the user is identified. Biometric device 401 generates a security signal to movable barrier operator 402 indicating the user is authorized. The user may access a user interface at remote device 404 and generate a command to movable barrier operator 402. Movable barrier operator receives the user's command and sends a signal to movable barrier 403 to open and allow entrance to the premises.

Another example, without limiting the scope of the present invention, is an automated system, wherein a user may enter his or her biometric parameter into biometric device 401 that may be embedded in remote device 404. Biometric device 401 may then analyze the biometric parameter for key markers and executes a search for an exact match of key markers authorized users. A database may contain the user's previously obtained biometric parameter. The database may be located, for example and without limiting the scope of the invention, at remote device 404, an access device, a central processing center or an off-site location accessible by the internet, wi-fi or telephone network. Once the user's biometric parameter matches the user's previously obtained biometric parameter with the same key markers in a database, the user is identified. Biometric device 401 may generate an automated command signal to movable barrier operator 402. Movable barrier operator 402 receives the user's command and sends the signal to movable barrier 403 to perform the command. Movable barrier 403 performs according to the command.

Turning to the last figure, FIG. 4(b) shows a block diagram of internal components of remote device 404 embedded with biometric device 401 that utilizes hardware to transmit biometric parameter in accordance to one embodiment of the present invention. Remote device 404 comprises of processor 450, memory 451, keyboard 452, display 453, transmitter 454, and biometric device 401.

Processor 450 governs the functionality of remote device 404 and the interactivity of its sub-components. Memory 451 is utilized by processor 450 to store parameter and to interpret and translate data for various sub-components of remote device 404. For example, should user input a command instruction into biometric device 401 or keyboard 452, processor 450 interprets and translates said command instruction, utilizing memory 451, in order to relay command instructions to transmitter 454 for transmission to movable barrier system 400.

Keyboard 452 may be a numerical input device, an alpha-numerical input device, a personal digital assistant keyboard, a simple multi-key input device, or any other type of input device for users to utilize remote device 404. Furthermore, keyboard 452 may be replaced by display 453. In one embodiment, display 453 comprises touch screen technology thus making keyboard 452 unnecessary. In another embodiment, keyboard 452 is only use as an alternative and primary interaction between users and remote device 404 is authorization by the biometric device to generate a security signal indicating that the user is authorized to control access.

Display 453 may be an LCD screen, or any other type of display without departing from the scope of the present invention. In addition, display 453 may display graphics to provide an aesthetically pleasing interface for users, and may be used as a means to display parameter such as instructions for individual users.

Display 453 may provide different visual options for users including messages regarding the device, for example, “LOCKED” or biometric parameter was “ACCEPTED” or that the user is “AUTHORIZED” to control access or that user is “DENIED” to control access.

Transmitter 454 may be any device capable of sending parameter to a receiver. In an exemplary embodiment transmitter 454 is capable of sending parameter wirelessly to a receiver. In another embodiment transmitter 454 is capable of sending parameter through a landline to a receiver.

A movable barrier system adapted to utilize biometric technology to identify and authorize control access to a premise has been described. The foregoing description of the various exemplary embodiments of the invention has been presented for the purposes of illustration and disclosure. It is not intended to be exhaustive or to limit the invention to the precise form disclosed. Many modifications and variations are possible in light of the above teaching. It is intended that the scope of the invention not be limited by this detailed description, but by the claims and the equivalents to the claims.

What is claimed is:

1. A system for controlling a movable barrier, comprising:
a biometric device adapted to sense a biometric parameter of a user and generate a security signal indicative of whether the user is authorized to control access; and
a movable barrier operator adapted to receive a command from the user and control the movable barrier in response to the command only if the security signal indicates that the user is authorized.

2. The system of claim 1, wherein said biometric device is capable of receiving a finger, scanning the finger to generate a fingerprint and matching the fingerprint to a pre-scanned fingerprint in a database.

3. The system of claim 1, wherein said biometric device is capable of receiving a hand, scanning the hand to generate a handprint and matching the handprint to a pre-scanned handprint in a database.

4. The system of claim 1, wherein said biometric device is capable of receiving a face, scanning the face to generate a facial image and matching the facial image to a pre-scanned facial image in a database.

5. The system of claim 1, wherein said biometric device is capable of receiving a retina, scanning the retina to generate a retinal image and matching the retinal image to a pre-scanned retinal image in a database.

6. The system of claim 1, wherein said biometric device is capable of receiving a voice, recording the voice to generate a digital voice image and matching the digital voice image to a pre-recorded digital voice in a database.

7. The system of claim 1, wherein said biometric device receives biometric parameter in close proximity to said movable barrier.

8. The system of claim 1, wherein said biometric device analyzes biometric parameter in close proximity to said movable barrier operator.

9. The system of claim 1, further comprising a wireless receiver adapted to receive transmission from a remote device.

10. The system of claim 9, wherein said biometric device receives biometric parameter at a remote location.

11. The system of claim 9, wherein said biometric device analyzes biometric parameter at a remote location.

12. The system of claim 9, wherein said biometric device analyzes biometric parameter in close proximity to said movable barrier.

13. The system of claim 9, wherein said biometric device analyzes biometric parameter at said movable barrier.

14. The system of claim 9, wherein said biometric device analyzes biometric parameter within said remote device.

15. The system of claim 9, wherein said biometric device analyzes biometric parameter adjacent to said remote device.

16. The system of claim 9, wherein said biometric device analyzes biometric parameter at said remote device.

17. The system of claim 14, wherein said biometric device transmits biometric information.

18. A system for controlling a movable barrier, comprising: a biometric device adapted to sense a biometric parameter of a user and generate a security signal indicative of whether the user is authorized to control access; and a movable barrier operator adapted to control the movable barrier in response to the security signal.

19. The system of claim 18, wherein said biometric device is capable of receiving a finger, scanning the finger to generate a fingerprint and matching the fingerprint to a pre-scanned fingerprint in a database.

20. The system of claim 18, wherein said biometric device is capable of receiving a hand, scanning the hand to generate a handprint and matching the handprint to a pre-scanned handprint in a database.

21. The system of claim 18, wherein said biometric device is capable of receiving a face, scanning the face to generate a facial image and matching the facial image to a pre-scanned facial image in a database.

22. The system of claim 18, wherein said biometric device is capable of receiving a retina, scanning the retina to generate a retinal image and matching the retinal image to a pre-scanned retinal image in a database.

23. The system of claim 18, wherein said biometric device is capable of receiving a voice, recording the voice to generate a digital voice image and matching the digital voice image to a pre-recorded digital voice in a database.

24. The system of claim 18, wherein said biometric device receives biometric parameter in close proximity to said movable barrier.

25. The system of claim 18, wherein said biometric device analyzes biometric parameter in close proximity to said movable barrier operator.

26. The system of claim 18, further comprising a wireless receiver adapted to receive transmission from a remote device.

27. The system of claim 26, wherein said biometric device receives biometric parameter at a remote location.

28. The system of claim 26, wherein said biometric device analyzes biometric parameter at a remote location.

29. The system of claim 26, wherein said biometric device analyzes biometric parameter in close proximity to said movable barrier.

30. The system of claim 26, wherein said biometric device analyzes biometric parameter at said movable barrier.

31. The system of claim 26, wherein said biometric device analyzes biometric parameter within said remote device.

32. The system of claim 26, wherein said biometric device analyzes biometric parameter adjacent to said remote device.

33. The system of claim 26, wherein said biometric device analyzes biometric parameter at said remote device.

34. The system of claim 31, wherein said biometric device transmits biometric information.
